(19) United States
(12) Patent Application Publication
(10) Pub. No.: US 2020/0023848 A1
(43) Pub. Date: Jan. 23, 2020

(54) DEVICE AND METHOD FOR OPTIMIZING THE ELECTRICAL POWER GENERATED BY AN ELECTRIC MACHINE IN THE COASTING MODE OF A VEHICLE

(71) Applicant: Robert Bosch GmbH, Stuttgart (DE)

(72) Inventor: Benedikt Kraus, Markgroeningen (DE)

(21) Appl. No.: 16/514,305

(22) Filed: Jul. 17, 2019

(30) Foreign Application Priority Data
Jul. 23, 2018 (DE) 102018212200.8

(51) Int. Cl. B60W 30/18

(52) U.S. Cl. CPC B60W 30/18072; B60W 2520/26; B60W 2710/08; B60K 6/26; B60W 30/18127; B60Y 2200/91; B60Y 2200/92; B60W 2030/1809

(57) ABSTRACT

A device for optimizing the electrical power generated by an electric machine in the coasting mode of a vehicle includes a module for computing a total regenerative torque or a variable proportional thereto, on the basis of which the electric machine is operated in generator mode. The module is configured to: compare the wheel slip that is present at at least one wheel of the vehicle to a predefined threshold value; reduce the total regenerative torque by a small amount when the ascertained wheel slip is less than the predefined threshold value; and increase the total regenerative torque by a small amount when the ascertained wheel slip is greater than the predefined threshold value. The reduction or increase takes place iteratively with multiple successive iteration steps.

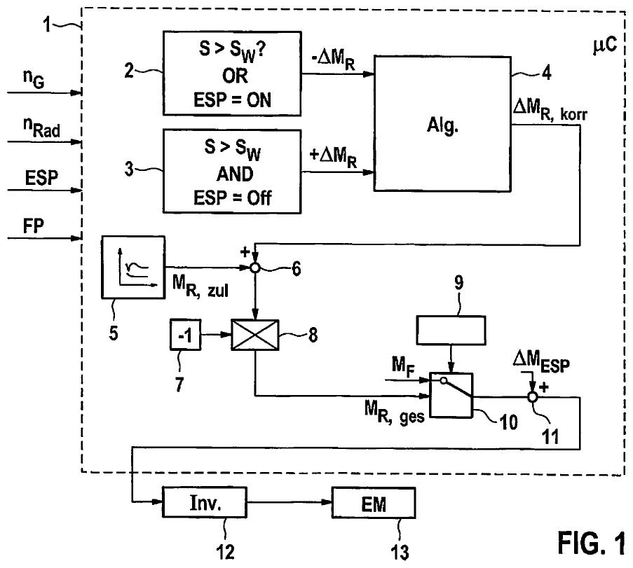

### CROSS-REFERENCE TO RELATED APPLICATIONS

The present application claims priority under 35 U.S.C. § 119 to DE 10 2018 212 200.8, filed in the Federal Republic of Germany on Jul. 23, 2018, the content of which is hereby incorporated by reference herein in its entirety.

### FIELD OF THE INVENTION

The present invention relates to a device and a method for optimizing the electrical power generated by an electric machine in the coasting mode of a vehicle, including a module for computing a total regenerative torque or a variable proportional thereto, on the basis of which the electric machine is operated in generator mode.

### BACKGROUND

Known vehicles with an electrical drive, such as purely electric vehicles or hybrid vehicles, generally include a recuperation system with which a portion of the kinetic energy can be recovered (recuperation) when the vehicle decelerates. During the recuperation, the electric drive or an electric machine is operated in generator mode, and can thus convert the kinetic energy that is released during deceleration of the vehicle into electrical energy. The recovered electrical energy is stored in an electrical energy store, for example the battery of the vehicle, and in other driving situations can then be used for driving the vehicle or for supplying electrical consumers. The recuperation in particular improves the efficiency of the vehicle, since only a relatively small remaining portion of the deceleration is converted into heat loss by the service brake.

During regenerative braking, the electric machine generates a drag torque which has a decelerating effect on the wheels of the vehicle. In critical driving conditions such as an icy or wet roadway, this can result in the wheel slip at one or multiple wheels increasing, and the vehicle going into an unstable borderline situation that requires intervention by a driving stability program (ESP). To prevent this, in conventional recuperation systems the drag torque exerted by the electric machine is preferentially set to conservative low values. As a result, however, in the majority of driving situations only partial use is made of the maximum possible recuperation. The remaining portion of the desired vehicle deceleration is provided by the service brake, as the result of which the efficiency of the system naturally suffers.

### SUMMARY

An object of the present invention, therefore, is to improve the efficiency of a recuperation system for recovering electrical energy.

According to an example embodiment of the present invention, a device for optimizing the electrical power generated by an electric machine in the coasting mode of a vehicle is provided, the device including a module for computing a total regenerative torque or a variable proportional thereto, on the basis of which the electric machine is operated in generator mode. The module is configured in such a way that it carries out at least the following functions: comparing the wheel slip that is present at at least one wheel of the vehicle to a predefined threshold value; reducing (or increasing the absolute value of) the total regenerative torque by a small amount when the ascertained wheel slip is less than the predefined threshold value (the total regenerative torque is a value less than zero, so that its absolute value becomes larger when it is reduced); and increasing (or reducing the absolute value of) the total regenerative torque by a small amount when the ascertained wheel slip is greater than the predefined threshold value. The reduction or increase in the total regenerative torque takes place in an iterative method with multiple successive iteration steps.

According to an example embodiment of the present invention, the module ascertains a so-called allowable regenerative torque which forms the basis for computing the total regenerative torque. The allowable regenerative torque can be ascertained, for example, from a characteristic map as a function of various driving state variables, or computed using an algorithm, as is customary in the related art.

According to the present invention, based on the absolute values of the reductions or increases ascertained in the individual iteration steps, the module ascertains a cumulative correction value with which the allowable regenerative torque is then corrected, in order to use this value to determine the stated total regenerative torque.

The individual absolute values of the reductions can all be equal or, depending on the driving situation, for example the speed of the vehicle, the magnitude of the wheel slip, or other parameters, can have different values. The same applies for the absolute values of the increases. For safety reasons, the absolute values of the reductions are preferably selected to be greater than the absolute values of the increases.

The cumulative correction value ultimately computed in a coasting phase of the vehicle is preferably stored, and then forms the starting value for correcting the allowable regenerative torque in a subsequent, new coasting phase of the vehicle.

According to the present invention, the total regenerative torque can be ascertained, for example, by adding the allowable regenerative torque and the correction value. The result can subsequently be further processed.

The stated module according to the present invention is preferably connected to a control electronics system for controlling the electric machine, such as an inverter known from the related art.

Moreover, the present invention relates to a method for optimizing the electrical power generated by an electric machine in the coasting mode of a vehicle, within the scope of the method a total regenerative torque or a variable proportional thereto being computed, on the basis of which the electric machine is operated in generator mode. According to an example embodiment of the present invention, the method includes: comparing the wheel slip that is present at at least one wheel of the vehicle to a predefined threshold value; reducing (or increasing the absolute value of) the total regenerative torque by a small amount when the ascertained wheel slip is less than the predefined threshold value; and increasing (or reducing the absolute value of) the total regenerative torque by a small amount when the ascertained wheel slip is greater than the predefined threshold value. The reduction or increase in the total regenerative torque takes place in an iterative method with multiple successive iteration steps.

According to an example embodiment of the present invention, the method is interrupted and a different total regenerative torque is set when a vehicle stability program is active.

The present invention is explained in greater detail below by way of example with reference to the appended drawing.

### BRIEF DESCRIPTION OF THE DRAWING

The FIGURE is a schematic illustration of a system for recuperation of electrical energy in the coasting mode of a vehicle, according to an example embodiment of the present invention.

### DETAILED DESCRIPTION

In the FIGURE, an electric machine 13 of a vehicle is shown which is operated in generator mode in a coasting phase of the vehicle, and which converts the kinetic energy that is released during deceleration of the vehicle into electrical energy. In generator mode, electric machine 13 generates a drag torque, which has a decelerating effect on the associated wheel(s).

The magnitude of the drag torque exerted by electric machine 13 is set by a power electronics system 12. For controlling electric machine 13, power electronics system 12 can vary, for example, an excitation voltage of electric machine 13 or a phase angle between the current and the voltage. Various methods for modifying the generator power of an electric machine are well known from the related art.

Power electronics system 12 at its input is connected to a module 1 for optimizing the electrical power generated by electric machine 13. At its output, stated module 1 outputs a total regenerative torque M_{R,ges} or a variable proportional thereto which represents total regenerative torque M_{R,ges}, and on the basis of which the generator power of electric machine 13 is then set.

Module 1 can be, for example, an arbitrary control unit or some other control device which processes software that ascertains above-mentioned total regenerative torque M_{R,ges}.

In the example embodiment illustrated in the FIGURE, total regenerative torque M_{R,ges} is ascertained as follows in principle: a so-called allowable regenerative torque M_{R,zul} is initially specified which forms the basis for the subsequent computation of total regenerative torque M_{R,ges}. Allowable regenerative torque M_{R,zul} can be predefined by a characteristic map 5, for example, which takes into account various driving state variables, for example a rotational speed n_{G} present at the gearbox output, a wheel speed n_{wheel}, surroundings conditions such as temperature or wetness, etc. Allowable regenerative torque M_{R,zul} ascertained based on characteristic map 5 is corrected with a correction value ΔM_{R,korr} that is continually recomputed in an iterative method.

In the illustrated example embodiment, allowable regenerative torque M_{R,zul} and cumulative correction value ΔM_{R,korr} are added at a node 6. The result is then multiplied by the factor −1 (block 7) in order to obtain total regenerative torque M_{R,ges} having the physically correct algebraic sign. The multiplier is schematically denoted by reference numeral 8.

A check is made in block 9 as to whether the vehicle is in coasting mode. As long as the driver is depressing accelerator pedal FP, the corresponding driver input torque specified by the driver at accelerator pedal FP is output by a block 10. If the driver does not depress accelerator pedal FP and the vehicle is thus in coasting mode, block 10 outputs the previously computed total regenerative torque. For the case that the vehicle stability program (ESP) is active, at a subsequent node 11 a torque that is requested by vehicle stability program ESP is added to the torque that is output by block 10. The resulting variable is then supplied to an inverter 12, which accordingly controls electric machine 13.

Above-mentioned correction value ΔM_{R,korr} that is added to allowable regenerative torque M_{R,zul} is a cumulative (positive) value that is ascertained in an iterative method and recomputed and stored in each iteration step. In the illustrated example embodiment, correction value ΔM_{R,korr} is likewise a positive value, and is ascertained essentially as follows: a comparison is made in step 2 as to whether the wheel slip present at at least one wheel is greater than a predefined threshold value SW, or whether vehicle stability program ESP is active. If one of the two conditions is met, a small reduction value −ΔM_{R} is output, which is then processed by a learning algorithm 4, which ascertains a new correction value ΔM_{R,korr} based on previous correction value ΔM_{R,korr} and reduction value −ΔM_{R}. When the vehicle is in coasting mode and wheel slip occurs, for example, correction value ΔM_{R,korr} is decremented, for example, by an amount per time increment. This takes place until the wheel slip has become less than threshold value SW.

A comparison is made in step 3 as to whether wheel slip S present at at least one wheel is less than a predefined threshold value SW, and whether at the same time vehicle stability program ESP is switched off. If both conditions are met, a small increase value +ΔM_{R} is output, which is then processed by a learning algorithm 4, which once again ascertains a new correction value ΔM_{R,korr} based on previous correction value ΔM_{R,korr} and increase value +ΔM_{R}. When the vehicle is in coasting mode and no wheel slip S occurs, correction value ΔM_{R,korr} is incremented, for example, by a corresponding amount per time increment. This takes place until a wheel slip S occurs that is greater than threshold value SW. The generator portion of a vehicle deceleration thus becomes continuously larger, and the portion from the service brake becomes correspondingly smaller, as the result of which the efficiency of the vehicle can be increased.

Last cumulative correction value ΔM_{R,korr} within a coasting phase of the vehicle is preferably stored by learning algorithm 4 as a new correction value ΔM_{R,korr} as a function of the operating point. In a new coasting phase of the vehicle, most recently stored correction value ΔM_{R,korr} can be used as a new starting value for correcting total regenerative torque M_{R,ges}.

What is claimed is:

1. A device for optimizing electrical power generated by an electric machine in a coasting mode of a vehicle, the device comprising:
a processor, wherein the processor is configured to:
compare a wheel slip that is present at at least one wheel of the vehicle to a predefined threshold value;
iteratively reduce, in a plurality of successive iteration steps, a total regenerative torque or a variable proportional to the total regenerative torque by a reduction amount when the ascertained wheel slip is less than the predefined threshold value; and
iteratively increase, in a plurality of successive iteration steps, the total regenerative torque or the variable by an increase amount when the ascertained wheel slip is greater than the predefined threshold value;
wherein the electric machine is operable in a generator mode based on the total regenerative torque or the variable.

2. The device of claim 1, wherein the processor is configured to:
ascertain, based on absolute values of the reduction amounts or increase amounts ascertained in the individual iteration steps, a correction value with which a predefined allowable regenerative torque is corrected; and
ascertain the total regenerative torque or variable based on the corrected allowable regenerative torque.

3. The device of claim 2, wherein the processor is configured to:
determine the allowable regenerative torque in a first coasting phase of the vehicle;
store the determined allowable regenerative torque; and
in a subsequent coasting phase, use the stored allowable regenerative torque as a starting value for correcting the total regenerative torque or variable.

4. The device of claim 2, wherein the processor is configured to determine the total regenerative torque or variable by adding the allowable regenerative torque and the correction value.

5. The device of claim 2, wherein the allowable regenerative torque is determined as a function of various driving state variables.

6. The device of claim 1, wherein the processor is connected to a control electronics system that is configured to control the electric machine.

7. A method for optimizing electrical power generated by an electric machine in a coasting mode of a vehicle, the method comprising:
comparing a wheel slip that is present at at least one wheel of the vehicle to a predefined threshold value;
iteratively reducing, in a plurality of successive iteration steps, a total regenerative torque or a variable proportional to the total regenerative torque by a reduction amount when the ascertained wheel slip is less than the predefined threshold value; and
iteratively increasing, in a plurality of successive iteration steps, the total regenerative torque or variable by an increase amount when the ascertained wheel slip is greater than the predefined threshold value;
wherein the electric machine is operable in a generator mode based on the total regenerative torque or the variable.

8. The method of claim 7, wherein the method is interrupted and a different regenerative torque is set when a vehicle stability program is active.
